(19) United States
(12) Patent Application Publication
(10) Pub. No.: US 2007/0109208 A1
(43) Pub. Date: May 17, 2007

(54) Antenna in a shielded enclosure

(75) Inventor: James B. Turner, Monroe, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/280,898

(22) Filed: Nov. 16, 2005

(51) Int. Cl. H01Q 1/12

(52) U.S. Cl. 343/718; 343/841

(57) ABSTRACT

An antenna disposed within a shielded enclosure, the antenna being disposed adjacent an electromagnetically transmissive closure member which covers a non-shielded aperture in the shielded enclosure. The electromagnetically transmissive closure member may, depending upon its dielectric properties, provide electromagnetic amplification for the antenna disposed thereunder to increase the effective signal propagation or reception.

### BACKGROUND

Antennas radiate or receive electromagnetic signals through media with varying degrees of effectiveness depending upon; inter alia, the dielectric properties of the media. Electromagnetic signal propagation through ordinary air may be used as a reference, the dielectric constant thereof being approximately 1 (a vacuum having a set value of 1). By comparison thereto, some materials provide better electromagnetic radiation propagation capabilities, such as for example certain glasses or ceramics which present dielectric constants of between about 5 and 10 or even higher. On the other hand, a variety of other materials have physical characteristics that inhibit or shield electromagnetic signals. Many metals exhibit such shielding properties.

Thus, any case or enclosure that is made of a metal or a like shielding material can cause signal propagation or reception problems for an antenna associated therewith, whether the antenna is merely connected to the enclosure or disposed inside. Indeed, the shielding material of such a case or enclosure can be highly restrictive of electromagnetic signals particularly when an antenna is disposed within the enclosure. The shielding material of the enclosure would then retard, if not completely block electromagnetic radiation to or from an antenna disposed within such a shielded enclosure.

A variety of enclosures that may be operatively associated with an antenna may have other antenna-inhibiting features as well. Providing a sealed, moisture-controlled environment within such an enclosure is such a feature that may inhibit or restrict the disposition of an antenna relative to any electronics within the enclosure whether by the actual restrictive disposition of the antenna relative to the casing or by the potentially inhibited electrical communication between the antenna and the electronics within the enclosure. The reasons for the inhibition are that a sealed enclosure either negates the poking of holes through any portion of the enclosure due to the ruining of the enclosure seal, or at least creates manufacturing difficulties in re-sealing any such holes made to accommodate an antenna or other projection. Many wrist-watches with metal cases provide examples of shielded, moisture sealed enclosures that can cause antenna problems such as these. Thus, well-sealed, waterproof or watertight watches provide distinct difficulties for the incorporation of an antenna thereon or therewithin.

### SUMMARY

Implementations described and claimed herein address the foregoing and other problems by providing an antenna within a shielded enclosure, but disposed in an electromagnetically exposed disposition relative to an electromagnetically transmissive closure member that covers a non-shielded aperture in the shielded enclosure. Such an implementation provides efficient signal radiation, reception and/or an ease of manufacturing and may also allow for maintaining a sealed enclosure for waterproofing or avoiding moisture ingress. Moreover, the electromagnetically transmissive closure member may, depending upon its dielectric properties, provide electromagnetic amplification for the antenna disposed thereunder to increase the effective signal propagation or reception. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTIONS OF THE DRAWINGS

FIG. 1 schematically illustrates a network of wireless communication devices.

FIG. 2 schematically illustrates the functional components of an electronic device.

FIG. 3 illustrates a watch with functional capabilities such as those in FIG. 2.

FIG. 4 illustrates a watch having an embedded antenna therein.

FIG. 5 is a cross-sectional view of a watch such as that of FIG. 4 taken along line 5/6-5/6 thereof.

FIG. 6 is another cross-sectional view of another watch such as that of FIG. 4 also taken along line 5/6-5/6 thereof.

FIG. 7 is a flow diagram of a method of manufacture which may be used herein.

### DETAILED DESCRIPTIONS

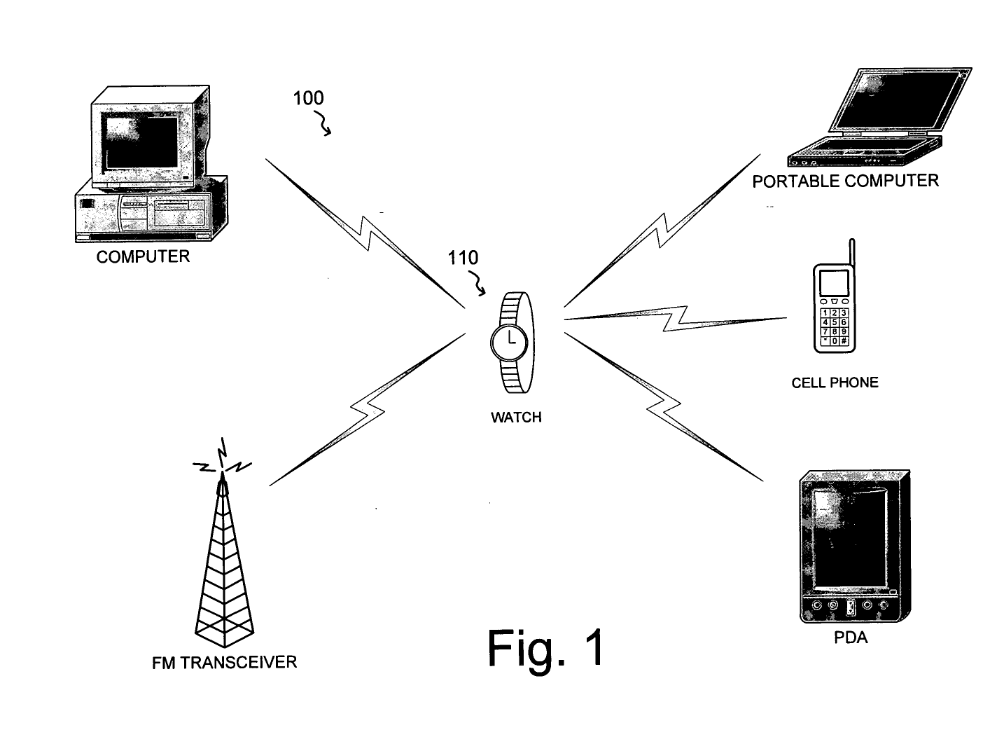

Technology is described here for disposing an antenna within a shielded enclosure such that the antenna provides efficient radiation, reception and/or ease of manufacturing. As will be described further below, such technology may be useful in a portable computing or communications device, and may be particularly useful in a wrist watch having wireless communication abilities. FIG. 1 illustrates an example operating environment 100 for just such an exemplar watch 110. Even though a watch is used as an exemplar here, it may be that other electronic devices having shielded enclosures may make use of an antenna system such as that described herein; a watch merely being one example. As illustrated in FIG. 1, the watch 110 may communicate with other devices within a local area communication network, a personal area network or other effective wireless communications network. More particularly, the watch 110 may communicate with, e.g., radiate signals to or receive signals from, an FM transceiver, or may communicate with other electronic devices by FM signals or through other means such as the IEEE 802.15.4 ZigBee standard or through Bluetooth connections. Such other electronic devices may include non-exhaustively a desktop computer, a portable computer, a wireless cellular telephone (mobile or cell phone), and/or a personal data assistant (PDA).

According to the technology described here, an antenna (not visible in FIG. 1) may be disposed within the watch 110 of FIG. 1, and may be disposed in proximity to the watch crystal or glass-type display cover. As many watch crystals or other glass or glass-type covers typically are non-shielding or electromagnetically transmissive, or indeed may have relatively high dielectric properties, the antenna may be disposed in sufficient proximity to the watch crystal as described herein (see detailed description below) to enhance electromagnetic signal propagation and/or reception of the antenna for enhanced wireless communications in an operating environment such as environment 100 of FIG. 1. Such an operating environment is only one example of a suitable operating environment for an antenna according to the technology hereof and is not intended to suggest any limitation as to the scope of use or functionality of the technology described herein.

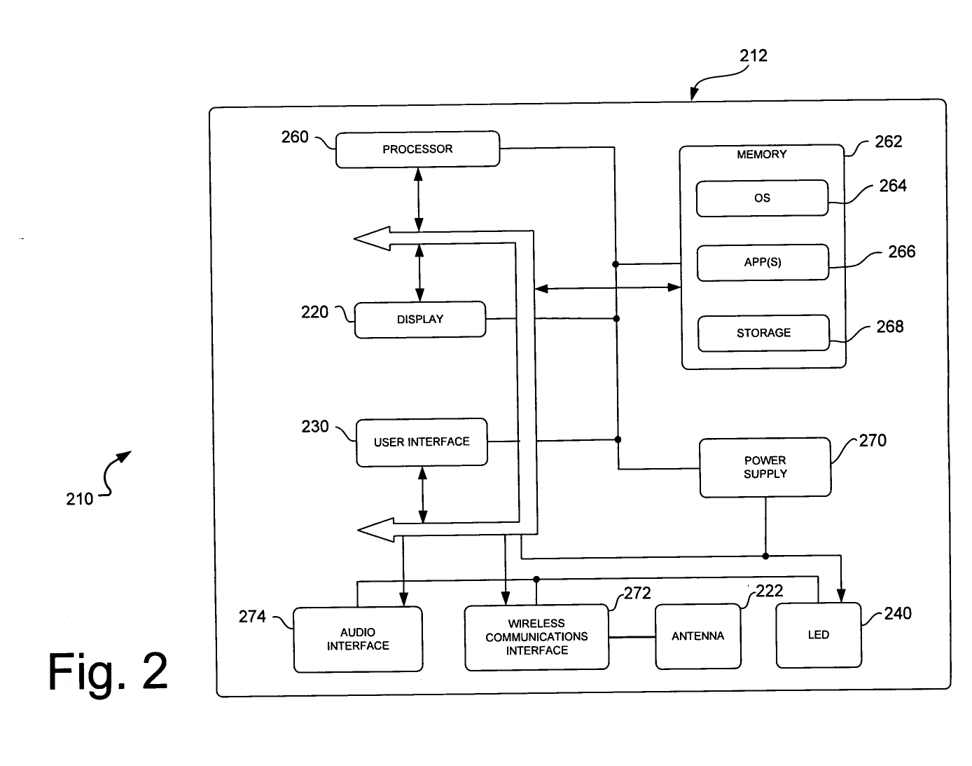

FIG. 2 is a schematic diagram illustrating some functional components that may be used in an illustrative electronic device 210, such as a wrist watch, which can make use of an antenna as described herein. The electronic device 210 may include an electrical or electronic system 212, which may include a computer-type of system having in one example, a processor 260, a memory 262, a display 220, and a user interface 230. The memory 262 may generally include either or both volatile memory (e.g., RAM) and non-volatile memory (e.g., ROM, Flash Memory, or the like). The electronic device 210 may also include an operating system 264 which may be resident in the memory 262 and execute on the processor 260. The user interface 230 may include a series of push buttons, a scroll wheel, a numeric dialing pad (such as on a typical telephone), and/or one or more other types of not specifically-enumerated user interface means. The display 220 may include a liquid crystal display, a multiple bit display, or a full color display or any other type of display commonly used in electronic devices. In one example, the display 220 may be touch-sensitive so that it may act as an input device.

One or more application programs 266 may be loaded into memory 262 and run on the operating system 264. Examples of application programs may include the following non-exhaustive listing of: phone dialer programs, email programs, scheduling/calendaring programs, PIM (personal information management) programs, Internet browser programs, and/or many others, like or even unlike those listed here. The electronic device 210 may also include a non-volatile storage 268 that can be located within the memory 262. The non-volatile storage 268 may be used to store persistent information that should not be lost if the electronic device 210 is powered down. The applications 266 may use and store information in the storage 268, such as e-mail or other messages used by an e-mail application, contact information used by a PIM, appointment information used by a scheduling program, documents used by a word processing application, and otherwise both like and even unlike those listed here.

The electronic device 210 has a power supply 270, which may be implemented as one or more batteries. The power supply 270 might further include an external power source, such as an AC adapter or a powered docking cradle that supplements or recharges the batteries.

The electronic device 210 is also shown in FIG. 2 with two types of external notification mechanisms: an LED 240 and an audio interface 274. The LED 240 may be responsive to programming to provide visual information to the user such as indicating a powered-on status for the device. The audio interface 274 may be used to provide audible signals to and receive audible signals from the user. For example, the audio interface 274 may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived message. The electronic device 210 can control each alert mechanism separately (e.g., audio, vibration, as well as visual cues).

The electronic device 210 also includes a wireless communications interface 272 that performs the function of receiving and/or transmitting wireless communications, such as radio frequency (e.g., FM) communications or Bluetooth or other communications. The wireless communications interface 272 facilitates wireless connectivity between the electronic device 210 and the outside world, either via a communications carrier or service provider or via Bluetooth or like communications with other devices. Wireless electromagnetic wave or signal transmissions are communicated to the interface 272 via an antenna 222 such as those antennas described throughout this description. Internal electronic circuitry transmissions to and from the wireless interface 272 may be conducted under control of the operating system 264. In other words, communications received by the wireless interface 272 may be disseminated to application programs 266 via the operating system 264, and vice versa, i.e., from the programs 266 and/or operating system 264 to the wireless interface 272. The wireless interface 272 then communicates with the antenna 222 to provide wireless communications for the device 210.

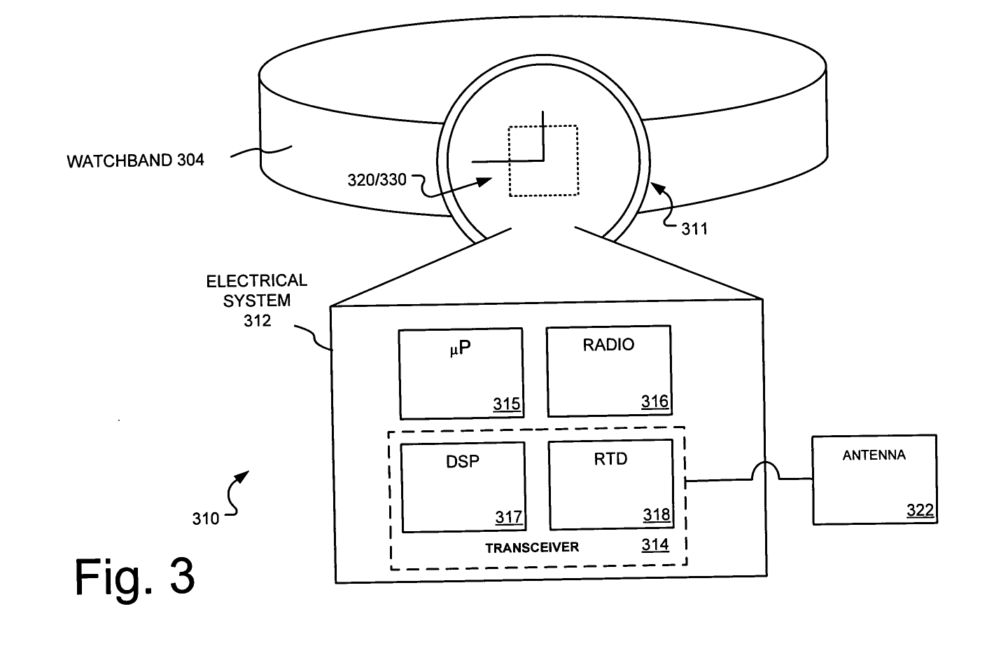

In one example of the described technology, electronic device 210 is a mobile electronic device such as a watch device that may include a wireless interface. More particularly, FIG. 3 illustrates an exemplary watch device 310 that includes a user display and user interface 330 that may be configured to take advantage of glanceable information technology. More generally, the watch device 310 may have a watchband 304 and a case or enclosure 311 attached to the watchband 304. The case or enclosure 311 has an electronic system 312 (see e.g., FIG. 2 and FIGS. 5 and 6 below) disposed therein. The enclosure 311 also has disposed therein a display element 320, such as, without limitation hereto, a liquid crystal display, a multiple bit display, or a full color display. In one implementation, watch hands may be electronically generated on the display 320. In an alternative implementation, the enclosure may include analog-type watch hands that do not detrimentally interfere with the display 320. The watch device 310 may include a series of buttons or like user interface features that are arranged to operate as a user interface (UI) 330. Note, the user interface may be on or may be a part of the display 320 or may be separate therefrom, and may be on or connected to the enclosure 311.

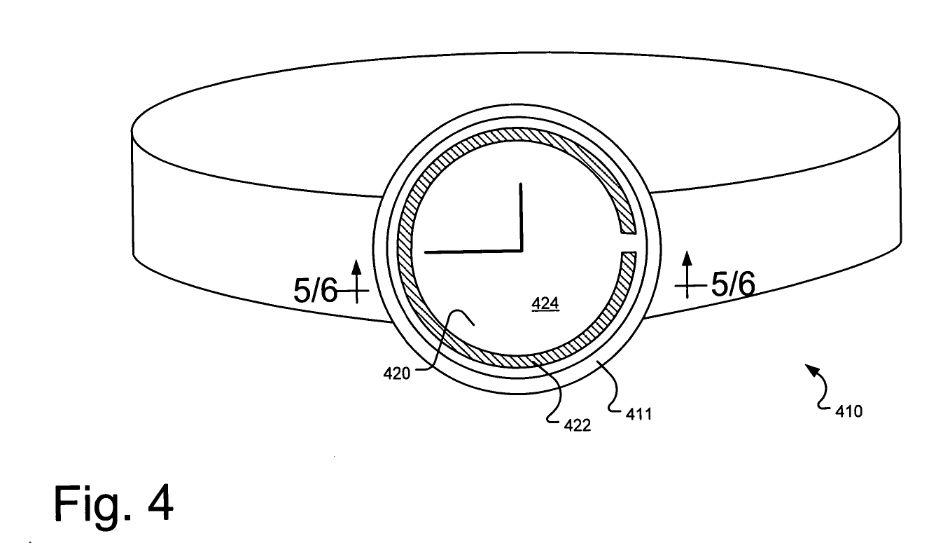

The electronic system 312 may be a computer-based or computer-like system, including functionality of operating as either or both a transmitter and/or a receiver, and/or may thus be or include a transceiver. Thus, as illustrated in FIG. 3, the electronic system 312 may include a transceiver 314 (schematically represented), a microcomputer unit or microprocessor (μP) 315, and may include an analog radio 316. An antenna 322 (and see FIGS. 4, 5 and 6) may be connected to the transceiver 314 for emitting and/or receiving information signals. The transceiver 314 may generally include a digital signal processor (DSP) 317, which performs control, scheduling, and post-processing tasks for the transceiver, and a real-time device (RTD) 318, which may include a digital radio, system timing, and real-time event dispatching. The DSP 317 may be coupled to the microprocessor 315, and transceiver tasks can thus be commanded by the microprocessor 315.

As introduced above, an antenna system is described here for an electronic device. More particularly, presented here is an antenna system for disposition within a mobile electronic device, such as a watch, for improving transmission and/or reception of electromagnetic signals when the antenna is disposed within a shielded enclosure of the electronic device. As will be further described with respect to FIGS. 4, 5 and 6, the antenna may thus be disposed in an electromagnetically exposed disposition relative to an unshielded aperture of the enclosure and an electromagnetically transmissive or non-shielding cover member. Though not limited to watches in all implementations, the described implementations present the electronic devices as smart watch type devices that are configured to receive and/or transmit wireless communication signals. Other electronic device examples with which an antenna hereof may be used include cell phones, PDAs, tablet computers, laptops, portable media players, portable gaming devices, and like or unlike devices.

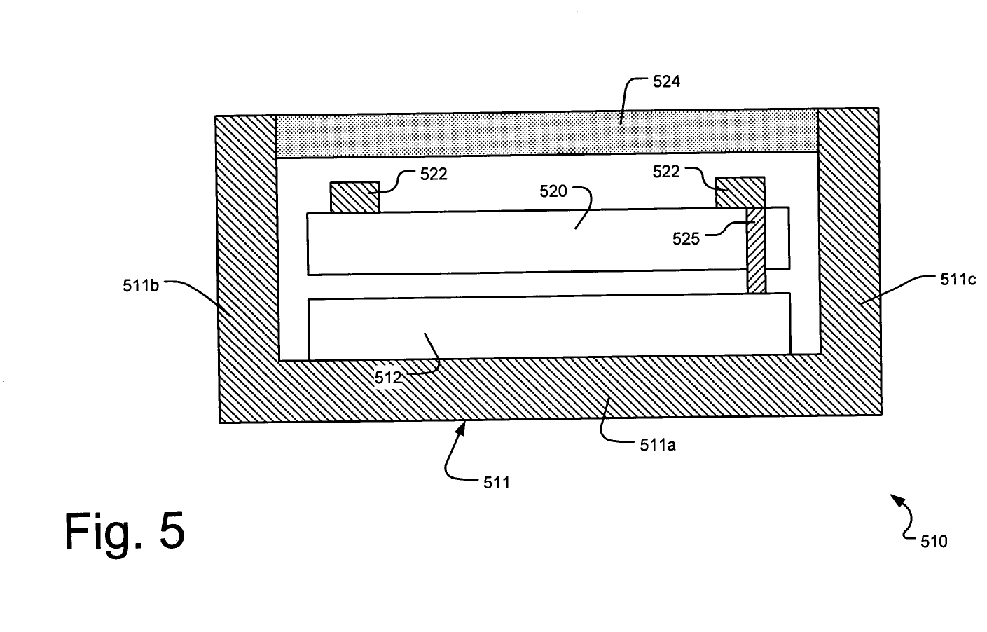

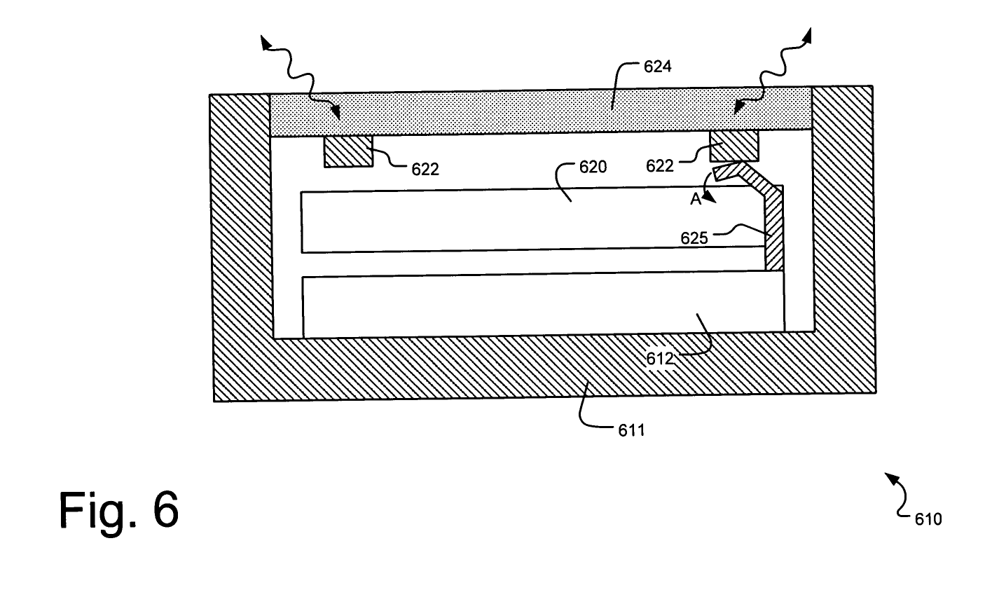

FIG. 4 presents a view of a watch device 410 having the technology hereof incorporated therein. More particularly, such a watch device 10 has an antenna 422 disposed within the enclosure 411 of the device 410. The antenna 422 is shown in FIG. 4 disposed adjacent and/or in an electromagnetically exposed disposition relative to the display 420 and the cover member 424. Note, the electromagnetically exposed disposition includes, without limitation, having the antenna disposed on, in or otherwise adjacent to the non-shielding or electromagnetically transmissive cover member. This also includes dispositions wherein the antenna is either in contact with the cover member or not in contact with the cover member, and includes alternatives wherein other members may be disposed between the antenna and the cover member. Furthermore, the cover member 424 here will typically be electromagnetically transmissive, and may, for display purposes, be a clear or substantially transparent or translucent watch crystal or glass cover; these nominatives being alternatively used hereinafter along with the cover nominative. In some implementations, the antenna may be fully visible above the display 420 below the watch or display crystal 424. This arrangement may be better seen in FIGS. 5 and 6 which are alternative cross-sectional views of the watch of FIG. 4.

With reference first to FIG. 5, an antenna 522 is shown disposed on and/or above a display element 520, below and adjacent a watch crystal or glass cover 524. The antenna 522 is thus disposed in an electromagnetically exposed disposition adjacent the cover 524 in order to avoid a substantial amount of the electromagnetic shielding of the case 511. The avoidance of the shielding of the case 511 is enhanced particularly by removing or disassociating the antenna 522 from the case bottom 511a and the case side walls 511b and 511c. This removal or disassociation may typically be maximized by bringing the antenna up to and in contact with, or disposed within the crystal, and may further include providing a spacing inward from the side walls 511b and 511c (this inward spacing being offset by minimizing any interference with the display surface). The antenna 522 may also be removed or disassociated from the electrical circuitry 512, though the antenna 522 is also shown as it may be electrically connected via a connection stem 525 to the electrical system 512, which is represented by a printed circuit board here. Disassociating the antenna from the printed circuit board and moving it to a position nearer if not mounted on or in the crystal increases the effectiveness of signal propagation and reception via the aperture of the enclosure 511. The aperture of the enclosure is defined by the side walls 511b and 511c and is closed off by the crystal 524. The enclosure 511 and the crystal or cover member 524 cooperate to create a compartment therewithin, the compartment being sealed in some implementations to be one or more of waterproof, watertight, water resistant, or resistant to the ingress of moisture.

FIG. 6 provides an alternative cross-sectional view in which the antenna 622 is disposed in contact with or attached to the crystal cover 624. The antenna then makes electrical connection with the circuitry 612 via the spring-topped electrical connection stem 625. The top of the electrical stem may be deflectable downwardly (see the arrow A in FIG. 6) to improve the manufacturability of the device, i.e., to ease assembly of the device. A manufacturability issue is how to connect the electric feed network from the transceiver IC, i.e., electrical circuitry 612, to the antenna 622. The metal case and the display, often a liquid crystal display, can cause issues in manufacturing methods and repeatable electrical performance of a feed network in a watch application. Using a deflectable stem 625, any inconsistencies in depth of the housing 611 or thickness of either the circuit board 612 or the crystal 624 can be compensated for by the adjustable height provided by the deflectable spring connection 625. In this fashion, the antenna may be manufactured on, i.e., fixed to the undersurface of the crystal 624 and put into place and simultaneously electrically connected when the crystal is fixed in place in the aperture in the enclosure 611.

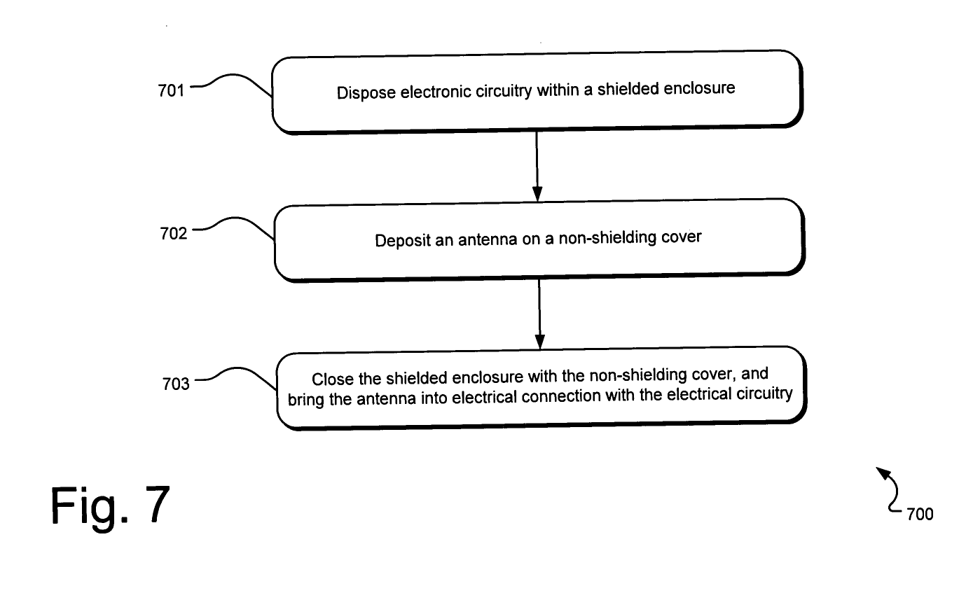

FIG. 7 provides a flow diagram of a manufacturing process 700 where, in an initial few operations 701 and 702, the electrical circuitry is placed in the enclosure (701), and the antenna is deposited on (or in) the cover member or crystal (702) (these operations taking place in no particular order relative to each other). Then, the watch cover or crystal with the antenna attached thereto, is put in position relative to the aperture of the enclosure bringing the antenna into an electrical connection with the electrical circuitry via the connecting stem. If a deflective stem is used such as that in FIG. 6, then, when the crystal is brought down into place relative to the aperture, the antenna is brought into contact with the deflective portion of the stem and makes an electrical connection regardless any potential inconsistency in enclosure depth or relative thicknesses of the circuit board or the display or the antenna itself. A spring-loaded feed network such as this may thus allow such watches to be assembled repeatably and rapidly by attaching the case last. This assembly process also allows easy manufacturing while keeping the moisture seal (see below) in place.

Note, the antenna may be disposed, inter alia, on top of the display (see FIG. 5), or immediately under the glass or crystal (see FIG. 6), or in position therebetween. It may be fixed in air space, as for example being held in place by the stem, or may be attached to the top surface of the display or to the under surface of the crystal or to another member (not shown), plastic, glass or otherwise. The antenna may be sandwiched between members as for example between the display and the crystal, or between the crystal or the display and one or more other members (not shown), or between two other members disposed between the crystal and the display. These attachments may be provided for any of various reasons such as for aesthetics (perhaps an exposed, i.e., viewable antenna may not be consumer-friendly, and may be covered with some alternative material, e.g., plastic which obfuscates view of the antenna), or for enhancing operability (some materials may magnify the electromagnetic signal transmission and/or reception, see below). Another possible solution is to attach the loop to low loss plastic with high dielectric constant that is directly under the glass but hides the loop from the consumer's view. Hiding the loop allows more variability in watch style. In broad terms, in either of the implementations of FIG. 5 or 6, the antenna may be generalized in disposition between the display and the cover. Alternatively and/or in addition hereto, other members may also be so disposed, and may thus either be simultaneously with the antenna be between the cover and the display or may be disposed either between the cover and the antenna (as for aesthetic purposes), or may be between the display and the antenna (as for support or other purposes). Such other members may be of shielding or more typically, of non-shielding materials to interfere less with the electromagnetic activity of the antenna. The atmosphere within this area may be filled with air or other gas or fluid or may be a vacuum. As introduced, the antenna may be manufactured to be disposed within the cover or crystal, so long as it is or is adapted to be electrically communicative with the feed circuit.

As for types of antennas, an antenna hereof is of an electromagnetically active material, such as a metal, e.g. silver or gold or both, e.g. a layer of silver and a layer of gold. Moreover, an antenna hereof may be a loop antenna as shown in FIG. 4 (and thus also in FIGS. 5 and 6), a loop antenna being a classic type of radiation aperture often used as an electrically small antenna. Electrically small antennas generally have poor radiation efficiency due to problems with low radiation resistance. However for electrically large antennas, the loop can be attractive because of its form factor and high radiation resistance. The diameter of the loop at resonance is one wavelength divided by PI (π) rather than a wavelength divided by 2 for a dipole. Although a monopole is even shorter (wavelength divided by 4), the monopole requires a substantial area for the required ground plane. Note the shape of the antenna used here need not be a circular loop; it may be elliptical or other rounded shape, or may be square, rectangular, or another polygonal shape, these being particularly useful for closed or substantially closed-“loop” shapes (as for example to match the display face of the electrical device), or the antenna may be a monopole or dipole as introduced above. Rounded shapes, polygonal and non-polygonal and other non-listed shapes of antennas may thus alternatively be used, particularly in taking advantage of known shape advantages where possible.

Various other antennas (chip, Planar Inverted F, or patch antennas) have constraints restricting watch use. A form factor consideration is the size of the watch. For the popular Industrial Scientific Medical unlicensed band of 2400 to 2483 MHz, the wavelength in air is 123 mm. This size of a loop would not fit on any plane surface of an ordinary watch. But by placing the loop on or nearly adjacent the glass or crystal face of the watch the required size for the physical metal antenna loop may be reduced because of the dielectric constant of the watch glass or crystal may magnify the antenna abilities (see more detailed description below).

As for watch considerations, when given no constraints, the loop antenna would be set for a circumference equal to one wavelength and have no surrounding metal or absorbing material. But in actual application, the surroundings are often constrained by other design choices. In particular for consumer wrist-watches, a metal case is very desirable for style or fashion or other functional purposes. But, as introduced above, a metal case can significantly degrade the antenna gain by moving the antenna gain from resonance and by shielding the desired electromagnetic radiation. When the case of the watch is metal or other shielding material, the problem with many antenna types used as part of a printed circuit board or mounted on or built-into the printed circuit board is that the antennas are “buried” inside the metal case. The metal case stops efficient radiation from these antenna types. The solution here is to dispose the radiating loop antenna as near the watch face as possible. This allows the antenna to have maximum “view” out from the metal case. Also the loop should be separated from the side walls of the case enough (see e.g., FIG. 4) to allow radiation without the capacitance from the case dominating the electrical path from the transmitter/receiver integrated circuit.

Note, as introduced above, using a high dielectric material for the watch crystal or glass face can increase or magnify the effective electromagnetic transmission and/or reception capability of the antenna relative to an antenna merely exposed to air. More particularly, a glass or watch crystal (dielectric constant of about 5, or even up to 10 or more) can cooperate with the antenna to make the antenna system electrically larger (the electromagnetic amplification or magnification from glass is better than air, air having a dielectric constant of about 1 as compared to the glass dielectric constant of about 5 or more). In this way, the antenna and the glass or crystal cover can create an antenna system. This helps to reduce the required size of the loop antenna itself, thereby allowing for attractive display faces and/or styles. Note, maintaining a sufficiently small antenna is desirable for reducing the amount of display face surface area (i.e., viewable space) to be hidden by the antenna. The shape or other characteristics of the antenna and/or the crystal may also contribute to the efficacy of the signal propagation and/or reception, as for example having a watch crystal with a particular shape which may further magnify the signal propagation and/or reception. Thus, e.g., a doming crystal might create a better antenna system for use with watches or other wireless communications devices.

Note also that a loop antenna such as is described here may also be embedded in a watch with a metal case in a manner to allow a moisture barrier (see below) and yet retain efficient methods for assembly. The antenna electrical feed assembly is soldered to the printed circuit board. The connection stem of the feed network makes pressure contact with the antenna as shown in FIG. 6. The skin depth of gold or silver antenna may be approximately (˜) 1.6 micrometers at 2.45 GHz. With two (2) skin depths of gold or silver on the top and bottom sides of the loop and a core of barrier metal the radio frequency (RF) loss is low. These small dimensions of metal can be cold deposited on the glass face of the watch. This loop antenna is planar and allows the feed circuit to contact the loop easily and reliably. The final matching of the antenna to the transceiver integrated circuit (IC) is accomplished by discrete inductances (Ls) and capacitances (Cs). A matching network of many known types may be used.

Another desirable feature may be using a metal case which remains sealed against the influx of moisture and/or water, and thus remains either waterproof, watertight or at least resistant to water or moisture ingress. The first issue here is that it is not easy in a manufacturing context to poke a hole through the skin of a case, primarily because it is not easy to re-seal such holes in a moisture or waterproof way, particularly without negatively impacting manufacturability or market-driven aesthetics. An antenna disposed entirely within an enclosure is thus desirable in maintaining waterproof or moisture resistant sealed enclosures without negative manufacturability or aesthetic issues.

The result is as described herein an antenna which is enclosable within an electromagnetically shielding enclosure, yet nevertheless providing an electrical device with wireless communications abilities for communications with computers, laptops, cell phones, headsets or the like, as for example, by Bluetooth communications. With computers, for example, electronic file(s) may be transferred through the air wirelessly, and perhaps automatically when in Bluetooth range. Music listening options may be enhanced with Bluetooth communications of songs on a watch or the like to a headset. Health and/or exercise-related devices such as those for monitoring physical signs (respiration, heart rate, etc.) may be enhanced by wireless communications to a computing-enabled watch hereof or the like. Other smart personal objects or personal artifacts may also communicate herewith as well.

The above specification, examples and data provide a complete description of the structure and use of exemplary implementations of the presently-described technology. Although various implementations of this technology have been described above with a certain degree of particularity, or with reference to one or more individual implementations, those skilled in the art could make numerous alterations to the disclosed implementations without departing from the spirit or scope of the technology hereof. Since many implementations can be made without departing from the spirit and scope of the presently described technology, the appropriate scope resides in the claims hereinafter appended. In particular, it should be understood that the described technology may be employed independent of a watch, a computer or like devices. Other implementations are therefore contemplated. Furthermore, it should be understood that any operations may be performed in any order, unless explicitly claimed otherwise or a specific order is inherently necessitated by the claim language. It is intended that all matter contained in the above description and shown in the accompanying drawings shall be interpreted as illustrative only of particular implementations and not limiting. Changes in detail or structure may be made without departing from the basic elements of the present technology as defined in the following claims.

Accordingly, what is claimed is:

1. An electronic device adapted for wireless communication, the electronic device comprising:
a shielded enclosure with an aperture;
an electromagnetically transmissive cover adapted to close the aperture of the enclosure;
electrical circuitry which provides for wireless communication, the electrical circuitry disposed within the shielded enclosure; and,
an antenna disposed within the shielded enclosure in an electromagnetically exposed disposition relative to the aperture and the electromagnetically transmissive cover, the antenna also being disposed in electrical communication with the electrical circuitry and to provide for one or both of electromagnetic signal transmission or reception through the electromagnetically transmissive cover and the aperture of the enclosure.

2. An electronic device according to claim 1 wherein the antenna is one of a loop, a dipole or a monopole.

3. An electronic device according to claim 1 wherein the shielded enclosure and the electromagnetically transmissive cover are adapted to create a sealed compartment therewithin, and wherein the sealed compartment is one or more of waterproof, water tight, water resistant, or resistant to ingress of moisture.

4. An electronic device according to claim 1 wherein the electromagnetically transmissive cover is one or more of electromagnetically magnifying or amplifying.

5. An electronic device according to claim 1 wherein the electromagnetically transmissive cover has a dielectric constant greater than that of air and wherein the electromagnetically transmissive cover is cooperative with the antenna to create an antenna system.

6. An electronic device according to claim 1 wherein the antenna is one of disposed in contact with the electromagnetically transmissive cover and disposed adjacent to, yet not in contact with the electromagnetically transmissive cover.

7. An electronic device according to claim 1 wherein the antenna is disassociated from the electrical circuitry and electrically connected thereto by an electrically conductive stem.

8. An electronic device according to claim 1 wherein the antenna is electrically connected to the electrical circuitry by an electrically conductive stem, the electrically conductive stem being one of fixedly attached to the antenna and spring contact attached to the antenna.

9. An electronic device according to claim 1 further including a display element disposed within the shielded enclosure and below both the electromagnetically transmissive cover and the antenna.

10. An antenna adapted to be disposed within a shielded enclosure, the shielded enclosure having an unshielded aperture and a non-shielding cover adapted to close the unshielded aperture of the shielded enclosure, the antenna comprising:
an electromagnetically active material disposed in an electromagnetically exposed disposition relative to one or both the unshielded aperture and the non-shielding cover when the non-shielding cover is disposed in closed position relative to the unshielded aperture;
wherein the antenna is disposed to one or both receive or transmit electromagnetic signals through the non-shielding cover and the unshielded aperture.

11. An antenna according to claim 10 wherein the shielded enclosure has disposed therewithin electronic circuitry which provides for wireless communication, and, wherein the antenna is disposed in electrical communication with the electronic circuitry.

12. An antenna according to claim 10 wherein the antenna is one of a loop, a dipole or a monopole.

13. An antenna according to claim 10 wherein the shielded enclosure and the non-shielding cover are adapted to create a sealed compartment therewithin, and wherein the sealed compartment is one or more of waterproof, water tight, water resistant, or resistant to ingress of moisture; and, wherein the antenna is disposed entirely within the sealed compartment.

14. An antenna according to claim 10 wherein the non-shielding cover is one or more of electromagnetically transmissive, electromagnetically magnifying and electromagnetically amplifying.

15. An antenna according to claim 10 wherein the non-shielding cover has a dielectric constant greater than that of air, and wherein the non-shielding cover is cooperative with the antenna disposed adjacent thereto to create an antenna system.

16. An antenna according to claim 10 wherein the antenna is disposed in one of in contact with the non-shielding cover and disposed adjacent to yet not in contact with the non-shielding cover.

17. An antenna according to claim 10 wherein the shielded enclosure has disposed therewithin electronic circuitry, and, wherein the antenna is disposed in electrical communication with the electronic circuitry, and wherein the antenna is disassociated from the electrical circuitry and electrically connected thereto by an electrically conductive stem.

18. An antenna according to claim 10 wherein the shielded enclosure has disposed therewithin electronic circuitry, and, wherein the antenna is disposed in electrical communication with the electronic circuitry, and wherein the antenna is electrically connected to the electrical circuitry by an electrically conductive stem, the electrically conductive stem being one of fixedly attached to the antenna and spring contact attached to the antenna.

19. An antenna according to claim 10 further including a display element disposed within the shielded enclosure and below both the non-shielding cover and the antenna.

20. A method of manufacture of an electronic device adapted for wireless communication, the electronic device including a shielding enclosure with an aperture, a non-shielding cover adapted to close the aperture, electronic circuitry, and, an antenna adapted to be disposed within the shielding enclosure adjacent the non-shielding cover, the antenna being adapted to communicate with the electronic circuitry and to provide for one or both of electromagnetic signal transmission or reception through the aperture of the enclosure; the method comprising:
disposing the electronic circuitry within the shielded enclosure;
depositing the antenna on the inner surface of the non-shielding cover; and,
closing the enclosure by setting the non-shielding cover in place relative to the aperture of the enclosure, wherein the antenna is brought into electrical connection with the electrical circuitry via contact with an electrically conductive stem, the electrically conductive stem becoming one of fixedly attached to the antenna and spring contact-attached to the antenna.
